(19) United States
(12) Patent Application Publication
(10) Pub. No.: US 2026/0326461 A1
(43) Pub. Date: Oct. 22, 2026

(54) RECORDING DEVICE AND MEDIUM TRANSPORT DEVICE

(71) Applicant: SEIKO EPSON CORPORATION, TOKYO (JP)

(72) Inventors: Hiroki SHINAGAWA, SHIOJIRI-SHI (JP); Hidefumi MINEMURA, SHIOJIRI-SHI (JP); Takumi WATANABE, MATSUMOTO-SHI (JP); Natori KADOTA, MATSUMOTO-SHI (JP); Kohei OKAWA, MATSUMOTO-SHI (JP)

(21) Appl. No.: 19/650,670

(22) Filed: Apr. 17, 2026

(30) Foreign Application Priority Data
Apr. 18, 2025 (JP) 2025-068643

(51) Int. Cl. B41J 13/03; B41J 25/00; F16H 7/08; F16H 7/12

(52) U.S. Cl. CPC B41J 13/03; B41J 25/005; F16H 7/1281; F16H 2007/0806; F16H 2007/0865; F16H 2007/0893; F16H 2007/0897

(57) ABSTRACT

A recording device includes a transport roller, a recording section, a motor, a first pulley, a second pulley, an endless belt, a tension applying member, a swing member, a first biasing member, a stopper, and second biasing member, wherein the stopper includes a first restriction section and a second restriction second restriction section, and the second biasing member biases the stopper so that the restricted section of the swing member is displaceable beyond the step from being restricted by the first restriction section to being restricted by the second restriction section.

The present application is based on, and claims priority from JP Application Serial Number 2025-068643, filed Apr. 18, 2025, the disclosure of which is hereby incorporated by reference herein in its entirety.

### BACKGROUND

### 1. Technical Field

The present disclosure relates to a recording device and a medium transport device.

### 2. Related Art

Various medium transport devices have been used in a recording device and the like. Among these, there is a medium transport device including an endless belt wound around a plurality of pulleys. For example, JP-A-2013-6665 discloses a recording device including the endless belt wound around a first pulley, a second pulley, and a drive pulley. Specifically, the recording device of JP-A-2013-6665 includes a tension application roller that applies tension to an endless belt, a holder member that pivotally supports the tension application roller and that changes the tension by swinging about a swing pivot point, a biasing member that biases the holder member in a direction in which the tension increases, and a stopper that restricts the swinging of the holder member in a direction in which the tension decreases.

In a configuration that includes the endless belt wound around a plurality of pulleys, due to the changes over time in the device, the endless belt may be stretched, the pulleys may be worn, or the positions of the pulleys may be changed. As described above, when the constituent members of the device change with time, the tension of the endless belt may change. When the tension of the endless belt changes, slipping, tooth skipping, or the like of the endless belt may occur. However, in the related-art medium transport device including the endless belt wound around the plurality of pulleys, it is difficult to appropriately maintain the tension of the endless belt in some cases. It should be noted that in the recording device of JP-A-2013-6665A, the tension of the endless belt can be maintained at an appropriate level in a normal state. However, in the recording device of JP-A-2013-6665A, since the stopper is fixed to the frame by screws in a state where the holder member abuts on the stopper, it may be difficult to appropriately maintain the tension of the endless belt with time.

### SUMMARY

A recording device includes a transport roller that applies a transporting force to a medium; a recording section that is located downstream of the transport roller in a transport direction of the medium and that performs recording on the medium transported by the transport roller; a motor that generates power for driving the transport roller; a first pulley receiving power from a motor shaft of the motor; a second pulley rotatable together with the transport roller; an endless belt wound around the first pulley and the second pulley; a tension applying member configured to press the endless belt in a tension applying direction in which tension is applied to the endless belt; a swing member configured to be swingable about a swing shaft, the swing member being provided with the tension applying member, the swing member being configured to change a degree of pressing of the tension applying member against the endless belt by swinging; a first biasing member configured to bias the swing member with respect to the endless belt in a first direction corresponding to the tension applying direction; a restriction section; a stopper that restricts the swing member from swinging in the tension reduction direction by the restriction section; and a second biasing member that biases the stopper toward the swing member, wherein swing member includes a restricted section that abuts against the restriction section, the stopper is configured to be displaceable and includes a first restriction section and a second restriction section as the restriction section, the first restriction section regulates the swinging of the swing member in the tension reduction direction by the restricted section abutting against the first restriction section, the second restriction section is adjacent to the first restriction section via a step and restricts the swing member from swinging in the tension reduction direction at a position shifted in the tension applying direction from a position in which the swing member is restricted by the first restriction section, and the second biasing member biases the stopper so that the restricted section is displaceable from a state of being regulated by the first restriction section to a state beyond the step of being regulated by the second restriction section.

A medium transport device includes a transport roller that applies a transporting force to a medium; a motor that generates power for driving the transport roller; a first pulley receiving power from a motor shaft of the motor; a second pulley rotatable together with the transport roller; an endless belt wound around the first pulley and the second pulley; a tension applying member configured to press the endless belt in a tension applying direction in which tension is applied to the endless belt; a swing member configured to be swingable about a swing shaft, the swing member being provided with the tension applying member, the swing member being configured to change a degree of pressing of the tension applying member against the endless belt by swinging; a first biasing member configured to bias the swing member with respect to the endless belt in a first direction corresponding to the tension applying direction; a stopper having a restriction section configured to restrict, in the restriction section, the swing member from swinging in a tension reduction direction; and a second biasing member configured to bias the stopper toward the swing member; wherein the swing member includes a restricted section that abuts against the restriction section, the stopper is configured to be displaceable and includes a first restriction section and a second restriction section as the restriction section, the first restriction section regulates the swinging of the swing member in the tension reduction direction by the restricted section abutting against the first restriction section, the second restriction section is adjacent to the first restriction section via a step and restricts the swing member from swinging in the tension reduction direction at a position shifted in the tension applying direction from a position in which the swing member is restricted by the first restriction section, and the second biasing member biases the stopper so that the restricted section is displaceable from a state of being regulated by the first restriction section to a state beyond the step of being regulated by the second restriction section.

### BRIEF DESCRIPTION OF THE DRAWINGS

FIG. 1 is a schematic diagram of a recording device according to a first embodiment of the present disclosure.

FIG. 2 is a perspective view illustrating a power transmission section of the recording device in FIG. 1, and that is a diagram illustrating a state in which a carriage does not abut on an actuating section.

FIG. 3 is a perspective view illustrating the power transmission section of the recording device of FIG. 1, and that is a diagram illustrating a state in which the carriage abuts on the actuating section.

FIG. 4 is a perspective view illustrating the power transmission section of the recording device of FIG. 1 as viewed from an angle different from that of FIG. 2, and that is a diagram illustrating a state in which the carriage does not abut on the actuating section.

FIG. 5 is a perspective view illustrating the power transmission section of the recording device of FIG. 1 as viewed from an angle different from that of FIG. 3, and that is a diagram illustrating a state in which the carriage abuts against the actuating section.

FIG. 6 is a side view illustrating the power transmission section of the recording device of FIG. 1, and that is a diagram illustrating a state in which the carriage does not abut on an actuating section.

FIG. 7 is a side view illustrating the power transmission section of the recording device in FIG. 1, and that is a diagram illustrating a state in which the carriage does not abut on an actuating section.

FIG. 8 is a schematic side view illustrating the power transmission section of the recording device of FIG. 1, and that is a diagram illustrating a state in which a restricted section is restricted by a first restriction section.

FIG. 9 is a schematic side view illustrating the power transmission section of the recording device of FIG. 1, and that is a diagram illustrating a state in which the restricted section is restricted by a second restriction section.

FIG. 10 is an exploded perspective view illustrating the power transmission section of the recording device of FIG. 1.

FIG. 11 is an exploded perspective view illustrating the power transmission section of the recording device of FIG. 1 as viewed from an angle different from that of FIG. 10.

FIG. 12 is an exploded perspective view illustrating a swing member and a tension applying member of the power transmission section of the recording device of FIG. 1.

FIG. 13 is a schematic side view illustrating the periphery of a tooth-shaped protrusion of a stopper of the power transmission section of the recording device of FIG. 1.

FIG. 14 is a schematic side view illustrating the power transmission section of the recording device of a second embodiment.

### DESCRIPTION OF EMBODIMENTS

Hereinafter, the present disclosure will be schematically described.

To overcome the above problem, a recording device according to a first aspect of the present disclosure includes a transport roller that applies a transporting force to a medium; a recording section that is located downstream of the transport roller in a transport direction of the medium and that performs recording on the medium transported by the transport roller; a motor that generates power for driving the transport roller; a first pulley receiving power from a motor shaft of the motor; a second pulley rotatable together with the transport roller; an endless belt wound around the first pulley and the second pulley; a tension applying member configured to press the endless belt in a tension applying direction in which tension is applied to the endless belt; a swing member configured to be swingable about a swing shaft, the swing member being provided with the tension applying member, the swing member being configured to change a degree of pressing of the tension applying member against the endless belt by swinging; a first biasing member configured to bias the swing member with respect to the endless belt in a first direction corresponding to the tension applying direction; a restriction section; a stopper that restricts the swing member from swinging in the tension reduction direction by the restriction section; and a second biasing member that biases the stopper toward the swing member, wherein the swing member includes a restricted section that abuts against the restriction section, the stopper is configured to be displaceable and includes a first restriction section and a second restriction section as the restriction section, the first restriction section regulates the swinging of the swing member in the tension reduction direction by the restricted section abutting against the first restriction section, the second restriction section is adjacent to the first restriction section via a step and restricts the swing member from swinging in the tension reduction direction at a position shifted in the tension applying direction from a position in which the swing member is restricted by the first restriction section, and the second biasing member biases the stopper so that the restricted section is displaceable from a state of being regulated by the first restriction section to a state beyond the step of being regulated by the second restriction section.

According to the present aspect, the stopper is configured to be displaceable, has the restriction section, and restricts the swing of the swing member in the tension reduction direction opposite to the tension applying direction in the restriction section. Here, the stopper is configured to be displaceable. The stopper includes the first restriction section and the second restriction second restriction section as the restriction section. The first restriction section restricts the swing of the swing member in the tension reduction direction by the restricted section abutting against the first restriction section. The second restriction section is adjacent to the first restriction section with a step therebetween. The second restriction section restricts the swing member from swinging in the tension reduction direction at a position shifted in the tension applying direction from a position where the swing member is restricted by the first restriction section. The second biasing member biases the stopper so that the restricted second restriction section is displaceable from a state where the restricted section is restricted by the first restriction section to a state beyond the step where the restricted section is restricted by the second restriction section. As described above, the recording device of the aspect includes the displaceable stopper. According to this aspect, even if the constituent members of the device such as the endless belt, the first pulley, and the second pulley change over time, the stopper can be displaced to an appropriate position to appropriately maintain the tension of the endless belt.

A recording device according to a second aspect of the present disclosure, further including a carriage on which the recording section is mounted and which is capable of reciprocal movement in a reciprocal movement direction intersecting the transport direction and a release mechanism configured to release engagement between the restricted section and the restriction section by movement of the carriage.

According to the aspect, the release mechanism that releases the engagement between the restricted section and the restriction section by the movement of the carriage is provided. With this configuration, the stopper can be displaced to an appropriate position with a simple configuration without increasing the number of new constituent members.

The recording device according to a third aspect of the present disclosure is a recording device according to an aspect dependent on the second aspect, wherein the release mechanism includes an actuating section that operates in a direction in which the stopper is separated from the swing member by movement of the carriage.

According to the aspect, the release mechanism includes the actuating section configured to operate in the direction in which the stopper is separated from the swing member by the movement of the carriage. With this configuration, the stopper can be displaced to an appropriate position with a particularly simple configuration.

The recording device according to a fourth aspect of the present disclosure is a recording device according to an aspect dependent on any one of the first to third aspects, wherein the tension applying member is configured by a roller and the swing member includes a holding section that rotatably holds the roller.

According to this aspect, the tension applying member is configured by the roller, and the swing member includes the holding section that rotatably holds the roller. With this configuration, the endless belt can be smoothly rotated.

The recording device according to a fifth aspect of the present disclosure includes, in an aspect dependent on any one of the first to fourth aspects, a recording device further including a housing that accommodates the recording section; a discharge roller that is located downstream of the recording section in the transport direction and that discharges the medium transported by the transport roller to the outside of the housing; and a third pulley rotatable with the discharge roller, wherein the endless belt is wound around the first pulley, the second pulley, and the third pulley.

According to the aspect, the endless belt is wound around the first pulley to which the power is transmitted from the motor shaft, the second pulley, which is rotatable together with the transport roller, and the third pulley, which is rotatable together with the discharge roller. With such a structure, the device can be simplified and downsized.

A medium transport device according to a first aspect of the present disclosure includes a transport roller that applies a transporting force to a medium; a motor that generates power for driving the transport roller; a first pulley receiving power from a motor shaft of the motor; a second pulley rotatable together with the transport roller; an endless belt wound around the first pulley and the second pulley; a tension applying member configured to press the endless belt in a tension applying direction in which tension is applied to the endless belt; a swing member configured to be swingable about a swing shaft, the swing member being provided with the tension applying member, the swing member being configured to change a degree of pressing of the tension applying member against the endless belt by swinging; a first biasing member configured to bias the swing member with respect to the endless belt in a first direction corresponding to the tension applying direction; a stopper having a restriction section configured to restrict, in the restriction section, the swing member from swinging in a tension reduction direction; and a second biasing member that biases the stopper toward the swing member, wherein the swing member includes a restricted section that abuts against the restriction section, the stopper is configured to be displaceable and includes a first restriction section and a second restriction section as the restriction section, the first restriction section regulates the swinging of the swing member in the tension reduction direction by the restricted section abutting against the first restriction section, the second restriction section is adjacent to the first restriction section via a step and restricts the swing member from swinging in the tension reduction direction at a position shifted in the tension applying direction from a position in which the swing member is restricted by the first restriction section, and the second biasing member biases the stopper so that the restricted section is displaceable from a state of being regulated by the first restriction section to a state beyond the step of being regulated by the second restriction section.

According to the aspect, the stopper includes the restriction section and that restricts the swing of the swing member in the tension reduction direction opposite to the tension applying direction in the restriction section. Here, the stopper is configured to be displaceable. The stopper includes the first restriction section and the second restriction second restriction section as the restriction section. The first restriction section restricts the swing of the swing member in the tension reduction direction by the restricted section abutting against the first restriction section. The second restriction section is adjacent to the first restriction section with a step therebetween. The second restriction section restricts the swing member from swinging in the tension reduction direction at a position shifted in the tension applying direction from a position where the swing member is restricted by the first restriction section. The second biasing member biases the stopper so that the restricted second restriction section is displaceable from a state where the restricted section is restricted by the first restriction section to a state beyond the step where the restricted section is restricted by the second restriction section. As described above, the medium transport device of the present aspect includes the displaceable stopper. According to this aspect, even if the constituent members of the device such as the endless belt, the first pulley, and the second pulley change over time, the stopper can be displaced to an appropriate position to appropriately maintain the tension of the endless belt.

### First Embodiment

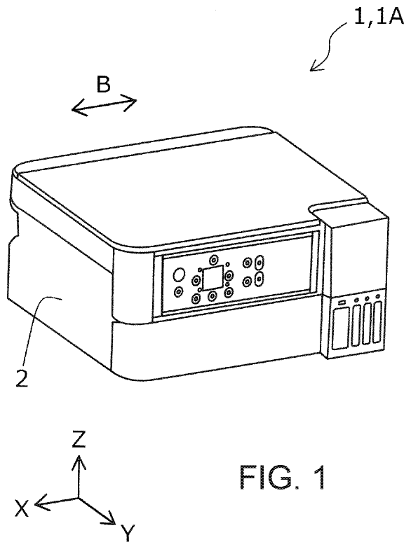

Hereinafter, a recording device 1A of a first embodiment as an example of a medium transport device and a recording device 1 of the present disclosure will be described in detail with reference to FIGS. 1 to 13. In the following description, three axes orthogonal to each other are referred to as an X-axis, a Y-axis, and a Z-axis, respectively, as illustrated in each drawing. The Z-axis direction corresponds to a vertical direction, that is, a direction in which gravity acts. The X-axis direction and the Y-axis direction correspond to horizontal directions. In each drawing, the directions indicated by the arrows of the three axes (X, Y, Z) are the + directions of each direction. For example, the X-axis direction corresponds to a reciprocal movement direction B of a carriage 3, the +X direction corresponds to the side on which a power transmission section 100 is provided, and the −X direction corresponds to the home position side of the carriage 3.

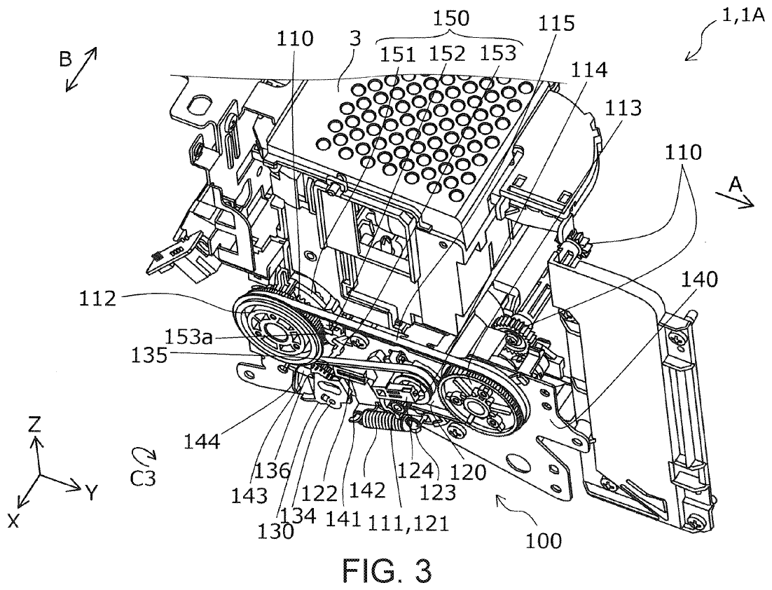

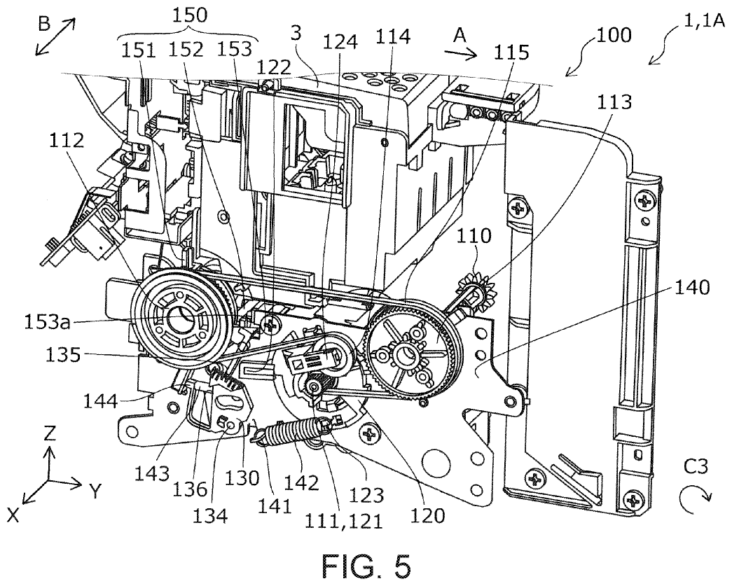

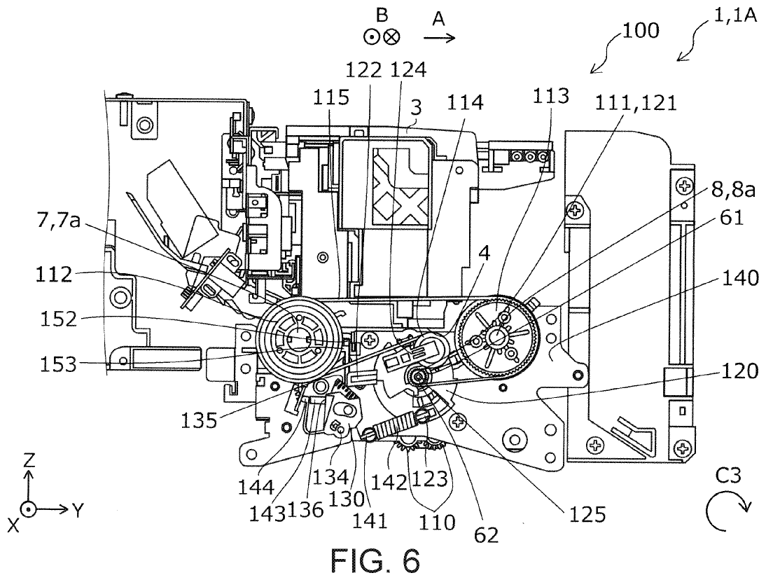

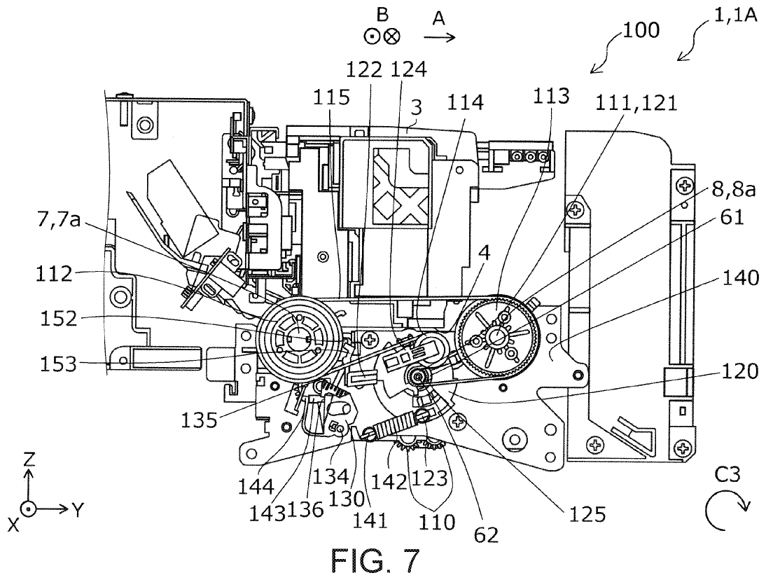

As illustrated in FIG. 1, the recording device 1A of the embodiment includes a housing 2. As illustrated in FIGS. 3 and 5, inside the housing 2, the carriage 3 that reciprocates in a reciprocal movement direction B along the X-axis direction is provided. As illustrated in FIGS. 6 and 7, on the carriage 3, a recording head 4 that discharges ink onto the medium to perform recording is mounted.

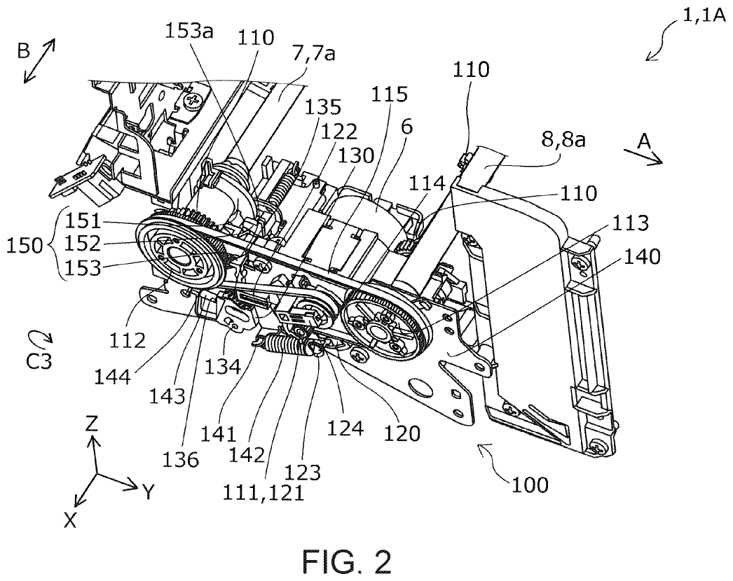

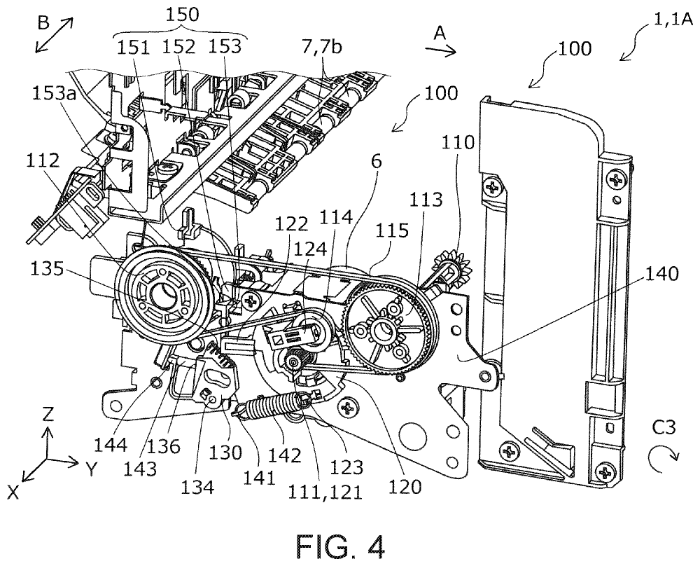

As illustrated in FIG. 2, the recording device 1A according to the present embodiment includes, inside the housing 2, a transport roller 7 that transports medium in a transport direction A and a discharge roller 8 that discharges the recorded medium. The transport roller 7 is configured by a roller pair including a drive roller 7a illustrated in FIG. 2 and a driven roller 7b illustrated in FIG. 4. The discharge roller 8 is also configured by a roller pair including a drive roller 8a illustrated in FIG. 2 and a driven roller (not illustrated). Further, the recording device 1 of the present embodiment further includes, inside the housing 2, a medium receiving tray (not illustrated) that receives the medium discharged by the discharge roller 8 and a motor 6 that is a power source of the transport roller 7 and the discharge roller 8.

The transmission of the power from the motor 6 to the drive roller 7a of the transport roller 7 and the drive roller 8a of the discharge roller 8 in the power transmission section 100 is performed as follows. As illustrated in FIGS. 2 to 5, a first pulley 111 is attached to a motor shaft 62 of the motor 6. An endless belt 115 is wound around the first pulley 111. Further, the endless belt 115 is, in addition to the first pulley 111, wound around a second pulley 112, a third pulley 113, and a pulley 114. The second pulley 112 is fixed to the drive roller 7a of the transport roller 7. The third pulley 113 is fixed to the drive roller 8a of the discharge roller 8. The pulley 114 is an example of a tension applying member, and that presses the endless belt 115 in a direction to apply tension to the endless belt 115.

The first pulley 111 rotates as the motor shaft 62 of the motor 6 rotates, and the endless belt 115 rotates accordingly. At this time, the drive roller 7a of the transport roller 7 and the drive roller 8a of the discharge roller 8 rotate with the rotation of the second pulley 112 and the third pulley 113. It should be noted that an encoder (not illustrated) that measures the rotation of the transport roller 7 is provided at the drive roller 7a of the transport roller 7. The power transmission section 100 includes a plurality of gears 110 forming a wheel train with the second pulley 112 and the third pulley 113. By rotating the plurality of gears 110, for example, a medium receiving tray (not illustrated) can be disposed so as to protrude to the outside from the housing 2.

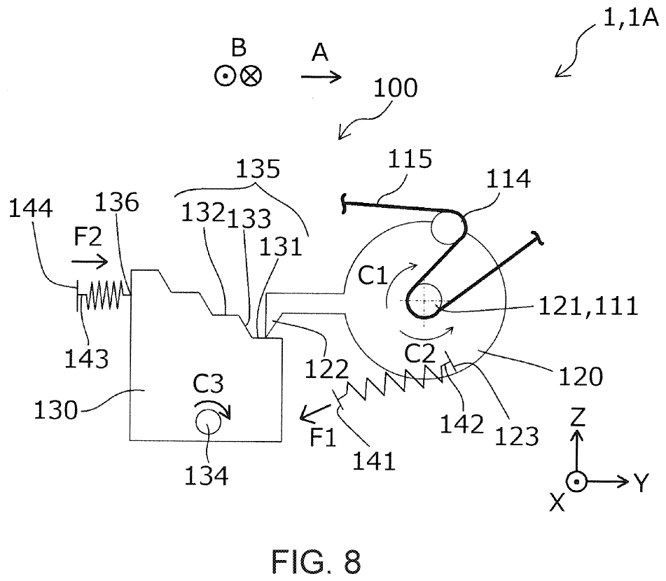

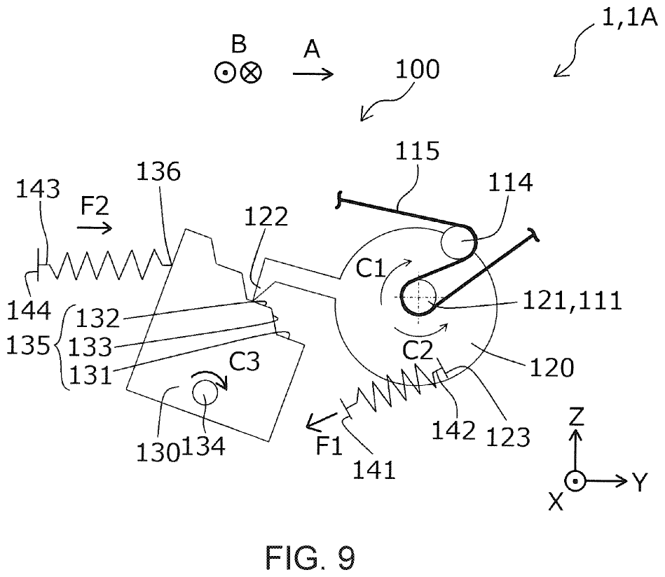

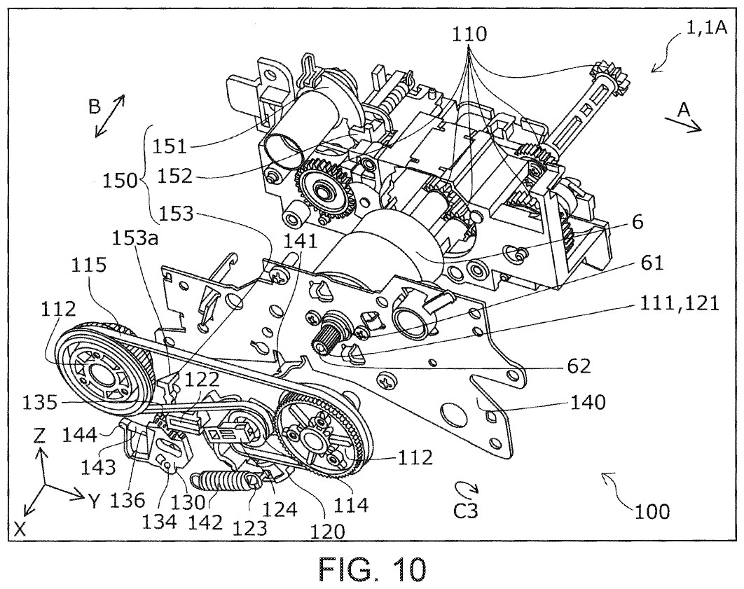

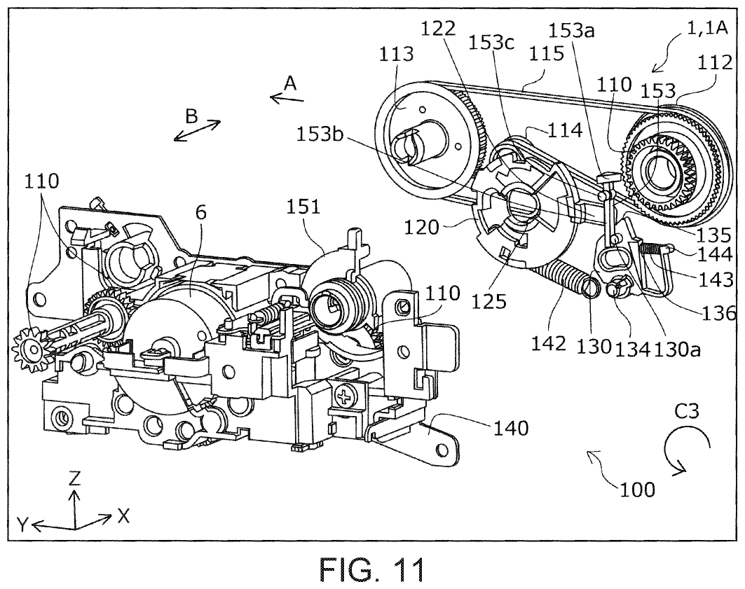

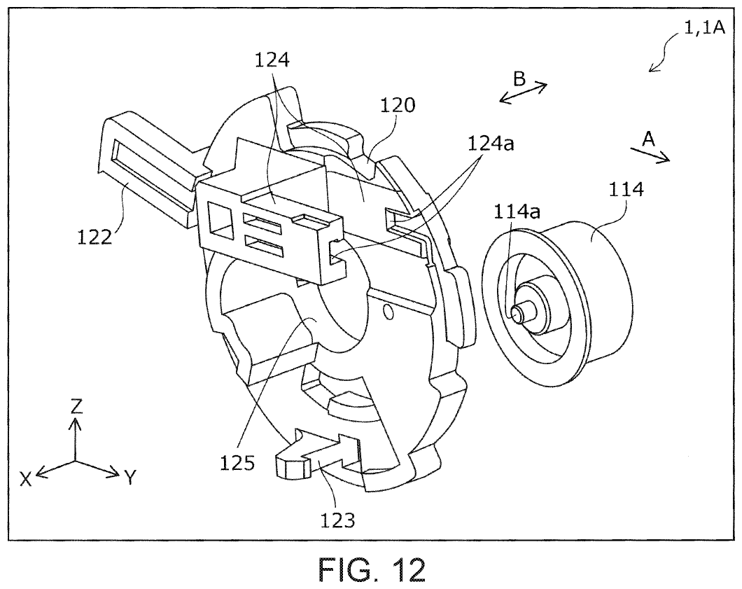

Here, as illustrated in FIGS. 2 to 11, the pulley 114 is axially supported by a swing member 120 that is swingable about the same axis as the first pulley 111. As illustrated in FIGS. 8 and 9, the swing member 120 is configured to be swingable in a tension applying direction C1 and a tension reduction direction C2 with the position of the first pulley 111 as a swing shaft 121. Specifically, as illustrated in FIGS. 11 and 12, the swing member 120 has a round hole section 125. The round hole section 125 is attached to a motor bearing 61 illustrated in FIG. 10 and the like. By this, the swing member 120 is, with respect to the motor 6 and a frame 140 (to be described later), held to be swingable in the tension applying direction C1 and a tension reduction direction C2. As illustrated in FIGS. 8 and 9, the swing member 120 is, by the spring force of a spring 142, biased in the first direction F1. By this, the pulley 114 applies tension to the endless belt 115 in the tension applying direction C1. The tension applying direction C1 is a direction in which tension is applied to the endless belt 115.

As illustrated in FIGS. 8 and 9, the swing member 120 is provided with a restricted section 122 having a protruding shape. A stopper 130 is provided in a position facing the restricted section 122. The stopper 130 restricts the swing of the restricted section 122 in the tension reduction direction C2. The tension reduction direction C2 is a direction in which the tension of the swing member 120 is decreased. As illustrated in FIGS. 2 to 7, the spring 142 is attached to a spring attachment section 141 of the frame 140 and a spring attachment section 123 of the swing member 120. In the present embodiment, the spring 142 is configured by a tension spring.

As illustrated in FIGS. 2 to 10, a plurality of tooth-shaped protrusions 135 are formed on the stopper 130. As illustrated in FIGS. 8 and 9, the tooth-shaped protrusion 135 is configured by a restriction section having a plurality of planar restriction surfaces such as a first restriction section 131 and a second restriction section 132, and a step 133 provided between the planar restriction sections. In other words, the stopper 130 includes, as the restriction section, the first restriction section 131 and the second restriction section 132. The restriction section restricts the swing of the swing member 120 in the tension reduction direction C2. The first restriction section 131 restricts, by the abutment of the restricted section 122, the swing of the swing member 120 in the tension reduction direction C2. The second restriction section 132 is adjacent to the first restriction section 131 via the step 133. The second restriction section 132 restricts the swing of the swing member 120 in the tension reduction direction C2 in a position shifted in the tension applying direction C1 as illustrated in FIG. 9 from a position where the swing member 120 is restricted by the first restriction section 131 as illustrated in FIG. 8.

It should be noted that the number of the restriction surfaces of the restriction section is not particularly limited. The positions of the first restriction section 131 and the second restriction section 132 in the tooth-shaped protrusion 135 is not particularly limited, and any adjacent restriction surfaces can be regarded as the first restriction section 131 and the second restriction section 132. In the present embodiment, the first restriction section 131 and the second restriction section 132 are planar regulating surfaces, but the present embodiment is not limited to such a configuration, and the first restriction section 131 and the second restriction section 132 may have, for example, a concave surface shape. However, the restriction surface is preferably flat because the restricted section 122 and the restriction section are easily re-engaged with each other after the release described later.

As illustrated in FIGS. 8 and 9, the stopper 130 includes a pivot shaft 134. The recording device 1A has a spring 143. The spring 143 biases the stopper 130 in the direction F2. By this, the stopper 130 is biased with reference to the pivot shaft 134 in a rotation direction C3. As illustrated in FIGS. 2 to 7, the spring 143 is attached to a spring attachment section 144 that abuts on the frame 140, and that is configured to bias the abutting section 136 of the stopper 130 toward the direction F2.

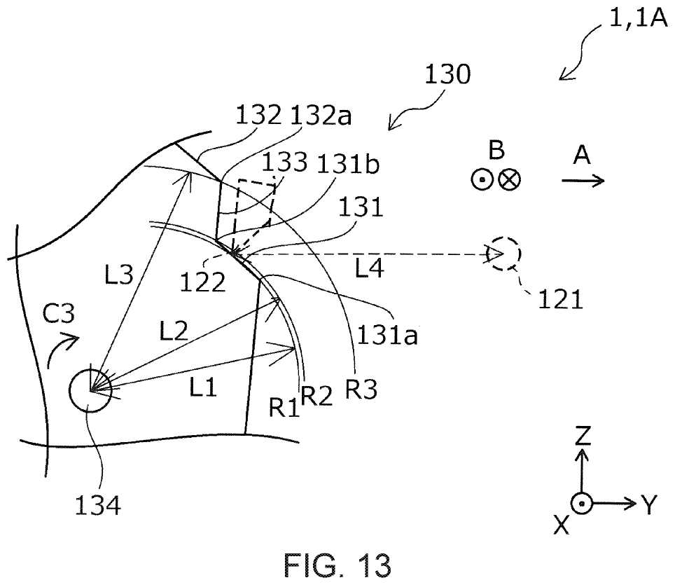

Referring to FIG. 13, the tooth-shaped protrusion 135 will be described in detail. In the stopper 130 of the present embodiment, the distance from the pivot shaft 134 to the tip end 131a of the first restriction section 131 of the tooth-shaped protrusion 135 is a distance L1. In the stopper 130, the distance from the pivot shaft 134 to a rear end 131b of the first restriction section 131 of the tooth-shaped protrusion 135 is a distance L2. Here, the distance L1 is smaller than the distance L2. This means that when the restricted section 122 initially abuts the tip end 131a, the abutting position is changed from the tip end 131a to the rear end 131b by extension of the endless belt 115. It should be noted that the endless belt 115 of the present embodiment is a timing belt with teeth, but is not limited to such a configuration, and that may be a friction belt or the like in which teeth or the like are not formed.

When the endless belt 115 is further extended by a predetermined distance from the state where the restricted section 122 abuts the rear end 131b, the abutting position of the restricted section 122 is moved to the tip end 132a of the second restriction section 132. Here, the distances from the pivot shaft 134 to the tip end 132a of the tooth-shaped protrusions 135 are distance L3, and the distance L2 are smaller than the distance L3. The ratio of the distance L3 to the distance L2 is greater than the ratio of the distance L2 to the distance L1. Therefore, in a state where the elongation of the endless belt 115 is small, tooth skipping, in which the restricted section 122 is shifted from a state of abutting the rear end 131b to a state where the restricted section 122 abuts the tip end 132a, is suppressed. In FIG. 13, the order distance of the distance L1, the distance L2, and the distance L3 is illustrated in an easily understandable manner. That is, FIG. 13 illustrates an arc R1 centered on the pivot shaft 134 corresponding to the distance L1. In FIG. 13, an arc R2 centered on the pivot shaft 134 corresponding to the distance L2 is illustrated. In FIG. 13, an arc R3 centered on the pivot shaft 134 corresponding to the distance L3 is illustrated.

In the present embodiment, the distance L1 is set to be longer than any of the distance L2, the distance L3, and the distance L4 illustrated in FIG. 13. The distance L4 is a length from an abutting position between the restriction section and the restricted section 122 to the swing shaft 121 of the swing member 120. In the Y-axis direction, the abutting position between the restriction section and the restricted section 122 is on the side closer to the swing shaft 121 than the pivot shaft 134, that is, on the +Y direction side of the pivot shaft 134. With this configuration, interference between the step 133 of the stopper 130 and the restricted section 122 can be easily avoided. By this, it is easy to prevent the swing member 120 from turning the stopper 130 more than necessary in the rotation direction C3. That is, it is possible to suppress the swing member 120 from swinging in the tension reduction direction C2.

Here, to summarize, the recording device 1A of the present embodiment includes the transport roller 7, the recording head 4 as a recording section, and the motor 6. The transport roller 7 applies a transporting force to the medium. The recording head 4 is located downstream of the transport roller 7 in the transport direction A of the medium. The recording head 4 performs recording on the medium transported by the transport roller 7. The motor 6 generates power for driving the transport roller 7. The recording device 1A of the present embodiment includes the first pulley 111, the second pulley 112, the endless belt 115, and the pulley 114 as a tension applying member. The first pulley 111 receives power transmitted from the motor shaft 62 of the motor 6. The second pulley 112 is rotatable together with the transport roller 7. The endless belt 115 is wound around the first pulley 111 and the second pulley 112. The pulley 114, by pressing the endless belt 115 in the tension applying direction C1, applies tension to the endless belt 115.

The recording device 1A includes a swing member 120 that is configured to be swingable about a swing shaft 121, is provided with a pulley 114, and that is capable of changing a degree of pressing of the pulley 114 against the endless belt 115 by swinging. The pulley 114 includes the spring 142 with respect to the endless belt 115 as a first biasing member that biases the swing member 120 in the first direction F1 corresponding to the tension applying direction C1. Here, the first direction F1 is a vertical direction in a direction of a line connecting the swing shaft 121 and the spring attachment section 123. The power transmission section 100 includes the stopper 130 that includes the restriction section such as the first restriction section 131 and the second restriction section 132 and that restricts the swing member 120 from swinging in the tension reduction direction C2 corresponding to the direction opposite to the first direction F1 in the restriction section. The power transmission section 100 includes the spring 143 as a second biasing member for biasing the stopper 130 toward the swing member 120 in the direction F2.

As described above, the swing member 120 includes the restricted section 122 that abuts on the restriction section.

The stopper 130 is configured to be, with respect to the pivot shaft 134, rotatable, that is, displaceable. The stopper 130 includes, as restriction sections, the first restriction section 131 and the second restriction section 132. The first restriction section 131 restricts, by the abutment of the restricted section 122, the swing of the swing member 120 in the tension reduction direction C2. The second restriction section 132 is adjacent to the first restriction section 131 via the step 133. The second restriction section 132 restricts the swing of the swing member 120 in the tension reduction direction C2 in a position shifted in the tension applying direction C1 from the position where the swing member 120 is restricted by the first restriction section 131. Further, the stopper 130 that is biased in the direction F2 by the spring 143 is displaceable from a state where the restricted section 122 is restricted by the first restriction section 131 to a state where the restricted section 122 is restricted by the second restriction section 132. It should be noted that the restricted section 122 moves over the step 133 in the process of changing from the state where the restricted section 122 is restricted by the first restriction section 131 to the state where the restricted section 122 is restricted by the second restriction section 132. With the above-described configuration, the recording device 1A of the present embodiment is configured to appropriately maintain the tension of the endless belt 115 even when the constituent members of the device such as the endless belt 115, the first pulley 111, and the second pulley 112 change over time.

As illustrated in FIGS. 2 to 7, the recording device 1A of the present embodiment includes a release mechanism 150 that is capable of releasing engagement between the restricted section 122 and the restriction section in the power transmission section 100. FIGS. 3, 5, and 7 illustrate a state where the engagement between the restricted section 122 and the restriction section is released from the state illustrated in FIGS. 2, 4, and 6, where the restricted section 122 and the restriction section are engaged. The release mechanism 150 includes a carriage abutting section 151, a movement section 152, and a lever 153.

The carriage abutting section 151, by being pressed in the +X direction by the carriage 3 moving in the +X direction, is configured to be movable in the +X direction. It should be noted that the carriage abutting section 151 has a fan shape and that is attached to the drive roller 7a. The carriage abutting section 151 is rotated by rotating the drive roller 7a and is can be displaced between a position where the carriage abutting section 151 contacts the carriage 3 and a position where the carriage abutting section 151 does not contact the carriage 3. The movement section 152 is configured to engage with the carriage abutting section 151 in the reciprocal movement direction B and to be movable along the reciprocal movement direction B together with the carriage abutting section 151.

The lever 153 has a contact section 153a. The contact section 153a, when viewed from the Z-axis direction, has an inclined surface inclined with respect to the reciprocal movement direction B. The lever 153 is configured to be rotatable in the rotation direction C3 around the pivot shaft 153c illustrated in FIG. 11, by the contact section 153a coming into contact with the movement section 152 that has moved in the +X direction from the state of FIGS. 2, 4, and 6. As illustrated in FIG. 11, the lever 153 includes an abutting section 153b that abuts against the protrusion section 130a of the stopper 130. When the lever 153 pivots in the rotation direction C3 about the pivot shaft 153c, the stopper 130 pivots in the direction opposite to the rotation direction C3. When the stopper 130 pivots in the direction opposite to the rotation direction C3, the engagement between the restricted section 122 and the restriction section is released as illustrated in FIGS. 3, 5, and 7 from the state in FIGS. 2, 4, and 6 in which the restricted section 122 and the restriction section are engaged with each other.

Then, when the carriage 3 moves again in the direction corresponding to the-X direction, the restricted section 122 and the restriction section engage with each other again. By the restricted section 122 and the restriction section engaging again after the restricted section 122 and the restriction section are released, even if the restricted section 122 and the restriction section are not engaged in the proper position, the restricted section 122 and the restriction section can be engaged in the proper position after the re-engagement. In particular, when a strong impact is applied to the recording device 1A or when the endless belt 115, which tends to loosen, is rotated in reverse, the restricted section 122 and the restriction section may engage with each other in a state displaced from the proper position. It should be noted that the case where the endless belt 115 is rotated in the reverse direction is a case where the motor 6 is rotated in the reverse direction. However, in such a case, the restricted section 122 and the restriction section can be engaged with each other in an appropriate position by releasing the restricted section 122 and the restriction section once and re-engaging them with each other.

As described above, the recording device 1A of the embodiment includes the carriage 3 and the release mechanism 150. The carriage 3 has the recording head 4 mounted thereon and is capable of reciprocating in the reciprocal movement direction B that intersects the transport direction A. The release mechanism 150 releases the engagement between the restricted section 122 and the restriction section by the reciprocal movement of the carriage 3.

With such a configuration, the recording device 1A of the present embodiment can displace the stopper 130 to the appropriate position with a simple configuration without increasing new constituent members.

In other words, the release mechanism 150 can be expressed as including the lever 153 as an actuating section that operates in a direction in which the stopper 130 is separated from the swing member 120 by the reciprocal movement of the carriage 3. This is because by displacing the stopper 130 from the state of FIGS. 2, 4, and 6 to the state of FIGS. 3, 5, and 7, then engagement between the restricted section 122 and the restriction section is released as illustrated in FIGS. 3, 5, and 7. By the recording device 1A of the present embodiment having such a configuration, it is possible to displace the stopper 130 in the appropriate position with a particularly simple configuration.

It should be noted that in the recording device 1A of the present embodiment, the lever 153 operates, via the carriage abutting section 151 and the movement section 152, in a direction in which the stopper 130 is separated from the swing member 120 by the reciprocal movement of the carriage 3. However, the configuration of the recording device 1A is not limited to such a configuration. For example, the lever 153 may be configured to directly abut against the carriage 3 by the reciprocal movement of the carriage 3 and operate in a direction in which the stopper 130 is separated from the swing member 120.

Here, as illustrated in FIG. 12 and the like, in the recording device 1A of the present embodiment, the tension applying member is the pulley 114, which is a roller. The swing member 120 includes a holding section 124 that rotatably holds the pulley 114, which is a roller. Specifically, the holding section 124 can rotatably hold the pulley 114 by fitting the recess section 124a of the pulley 114 into the protrusion section 114a of the holding section 124. The recording device 1A of the present embodiment is configured as described above, and thus the endless belt 115 can be smoothly rotated and moved. However, the present disclosure is not limited to such a configuration, and the tension applying member may be, for example, a cylindrical member integrally molded with the holder.

The recording device 1A of the embodiment includes the housing 2 that accommodates constituent members such as the recording head 4 as illustrated in FIG. 1. Further, as described above, the recording device 1A includes the discharge roller 8 and the third pulley 113. The discharge roller 8 is located downstream of the recording head 4 in the transport direction A. The discharge roller 8 discharges the medium transported by the transport roller 7 to the outside of the housing 5. The third pulley 113 is rotatable together with the discharge roller 8. As illustrated in FIGS. 2 to 7, the endless belt 115 is wound around the first pulley 111, the second pulley 112, and the third pulley 113. The recording device 1A of the present embodiment has such a configuration, and thus the recording device 1 can be simplified and downsized.

### Second Embodiment

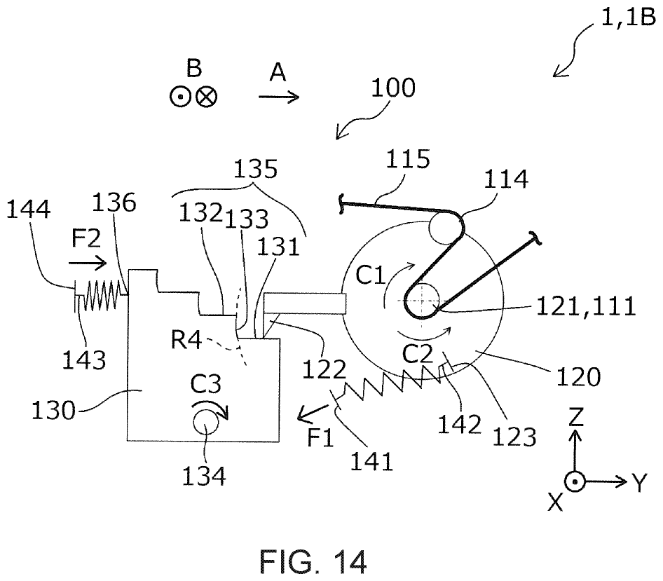

Next, a recording device 1B of the second embodiment will be described with reference to FIG. 14. FIG. 14 is a diagram corresponding to FIG. 8 in the recording device 1A of the first embodiment. In FIG. 14, constituent members common to those of the first embodiment are denoted by the same reference symbols, and detailed description thereof will be omitted. It should be noted that the recording device 1B of the present embodiment has the same configuration as the recording device 1A of the first embodiment except for the configuration of the step 133. For this reason, the recording device 1B of the present embodiment has the same features as those of the recording device 1A of the first embodiment except for the parts described below.

As illustrated in FIG. 14, in the recording device 1A of the present embodiment, the step 133 has a shape along an arc R4 with the swing shaft 121 of the swing member 120 as a reference. With this configuration, unnecessary swinging of the stopper 130 is suppressed, and the durability of the stopper 130 and the swing member 120 can be improved.

The present disclosure is not limited to the above-described embodiments and can be realized by various configurations without departing from the scope of the spirit. The technical features in the embodiments corresponding to the technical features in each aspect described in the outline of the present disclosure can be appropriately replaced or combined in order to overcome a part or all of the problems described above or in order to achieve a part or all of the effects described above. If the technical features are not described as essential in the present specification, the technical features can be appropriately omitted.

What is claimed is:

1. A recording device comprising:
a transport roller that applies a transporting force to a medium;
a recording section that is located downstream of the transport roller in a transport direction of the medium and that performs recording on the medium transported by the transport roller;
a motor that generates power for driving the transport roller;
a first pulley receiving power from a motor shaft of the motor;
a second pulley rotatable together with the transport roller;
an endless belt wound around the first pulley and the second pulley;
a tension applying member configured to press the endless belt in a tension applying direction in which tension is applied to the endless belt;
a swing member configured to be swingable about a swing shaft, the swing member being provided with the tension applying member, the swing member being configured to change a degree of pressing of the tension applying member against the endless belt by swinging;
a first biasing member configured to bias the swing member with respect to the endless belt in a first direction corresponding to the tension applying direction;
a restriction section;
a stopper provided in the restriction section for restricting the swing member from swinging in a tension reduction direction; and
a second biasing member that biases the stopper toward the swing member, wherein
the swing member includes a restricted section that abuts against the restriction section,
the stopper is configured to be displaceable and includes a first restriction section and a second restriction section as the restriction section,
the first restriction section regulates the swinging of the swing member in the tension reduction direction by the restricted section abutting against the first restriction section,
the second restriction section is adjacent to the first restriction section via a step and restricts the swing member from swinging in the tension reduction direction at a position shifted in the tension applying direction from a position in which the swing member is restricted by the first restriction section, and
the second biasing member biases the stopper so that the restricted section is displaceable from a state of being regulated by the first restriction section to a state beyond the step of being regulated by the second restriction section.

2. The recording device according to claim 1, further comprising:
a carriage on which the recording section is mounted and which is capable of reciprocal movement in a reciprocal movement direction intersecting the transport direction and
a release mechanism configured to release engagement between the restricted section and the restriction section by movement of the carriage.

3. The recording device according to claim 2, wherein
the release mechanism includes an actuating section that operates in a direction in which the stopper is separated from the swing member by movement of the carriage.

4. The recording device according to claim 3, wherein
the tension applying member is configured by a roller and
the swing member includes a holding section that rotatably holds the roller.

5. The recording device according to claim 4, further comprising:
a housing that accommodates the recording section;
a discharge roller that is located downstream of the recording section in the transport direction and that discharges the medium transported by the transport roller to the outside of the housing; and
a third pulley rotatable with the discharge roller, wherein
the endless belt is wound around the first pulley, the second pulley, and the third pulley.

6. A medium transport device comprising:
a transport roller that applies a transporting force to a medium;
a motor that generates power for driving the transport roller;
a first pulley receiving power from a motor shaft of the motor;
a second pulley rotatable together with the transport roller;
an endless belt wound around the first pulley and the second pulley;
a tension applying member configured to press the endless belt in a tension applying direction in which tension is applied to the endless belt;
a swing member configured to be swingable about a swing shaft, the swing member being provided with the tension applying member, the swing member being configured to change a degree of pressing of the tension applying member against the endless belt by swinging;
a first biasing member configured to bias the swing member with respect to the endless belt in a first direction corresponding to the tension applying direction;
a stopper having a restriction section configured to restrict, in the restriction section, the swing member from swinging in a tension reduction direction; and
a second biasing member that biases the stopper toward the swing member, wherein
the swing member includes a restricted section that abuts against the restriction section,
the stopper is configured to be displaceable and includes a first restriction section and a second restriction section as the restriction section,
the first restriction section regulates the swinging of the swing member in the tension reduction direction by the restricted section abutting against the first restriction section,
the second restriction section is adjacent to the first restriction section via a step and restricts the swing member from swinging in the tension reduction direction at a position shifted in the tension applying direction from a position in which the swing member is restricted by the first restriction section, and
the second biasing member biases the stopper so that the restricted section is displaceable from a state of being regulated by the first restriction section to a state beyond the step of being regulated by the second restriction section.
